(19) United States
(12) Patent Application Publication
(10) Pub. No.: US 2018/0183700 A1
(43) Pub. Date: Jun. 28, 2018

(54) NETWORK TEST METHOD, NETWORK TEST APPARATUS, AND NON-TRANSITORY COMPUTER-READABLE STORAGE MEDIUM

(71) Applicant: FUJITSU LIMITED, Kawasaki-shi (JP)

(72) Inventors: Tatsuya Ishikawa, Sumida (JP); Tsuyoshi Harada, Setagaya (JP); Hisashi Takahashi, Kawasaki (JP); Yusuke Masuyama, Kawasaki (JP)

(73) Assignee: FUJITSU LIMITED, Kawasaki-shi (JP)

(21) Appl. No.: 15/851,421

(22) Filed: Dec. 21, 2017

(30) Foreign Application Priority Data
Dec. 28, 2016 (JP) 2016-255261

(51) Int. Cl. H04L 12/26; H04L 12/24

(52) U.S. Cl. CPC H04L 43/50; H04L 41/12

(57) ABSTRACT

A network test method includes acquiring information of a type of each of a plurality of terminals and a coupling relationship of the plurality of terminals in a network, creating a test item of a communication test and a network path which becomes the target of the test, acquiring setting information including a switching time period of a terminal or terminals related to a redundant configuration, predicting a result of a communication test, requesting the result which carried out in the network, evaluating communication in the network by performing comparison between a result of the prediction and the test result which carried out in the network.

### CROSS-REFERENCE TO RELATED APPLICATION

This application is based upon and claims the benefit of priority of the prior Japanese Patent Application No. 2016-255261, filed on Dec. 28, 2016, the entire contents of which are incorporated herein by reference.

### FIELD

The present technology relates to a network test apparatus and method.

### BACKGROUND

When a communication test of a network including a plurality of apparatus coupled to each other is to be performed, usually a manager of the network extracts test items from sequence definitions, frame definitions described in a specification for the network, and performs a network test for each of the extracted items to perform evaluation of the network.

Related art is disclosed in Japanese Laid-open Patent Publication No. 2009-181560.

### SUMMARY

According to an aspect of an embodiments, a network test method includes acquiring information of a type of each of a plurality of terminals included in a network and a coupling relationship of the plurality of terminals, creating, based on the acquired information of the types of the plurality of terminals and the coupling relationship of the plurality of terminals, a test item of a communication test to be executed in the network and a path of the network when a test corresponding to the test item is to be performed, acquiring setting information including a switching time period of a terminal or terminals having a redundant configuration from among the plurality of terminals included in the created path of the network from information processing terminals included in the network, predicting, based on the switching time period acquired from the information processing terminals, a result of the communication test according to the switching time period in the path of the network through the terminal or terminals having the redundant configuration, requesting the information processing terminals included in the network to carry out the communication test, and evaluating communication in the network by performing comparison between a result of the prediction and the result of the communication test acquired from the information processing terminals included in the network for which the communication test is executed in response to the request.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view depicting an example of a configuration of a network system that performs a test according to an embodiment;

FIG. 2 is a view depicting an example in which a network test apparatus is installed in the network system depicted in FIG. 1;

FIG. 3 is a view depicting an example of a configuration of a network test apparatus and an information collection apparatus according to the present embodiment;

FIG. 4 is a view depicting a particular example of a network system according to the present embodiment;

FIG. 5 is a view depicting an example of a table of configuration information of a network system stored in a network information storage unit;

FIG. 6 is a view depicting an example of a table of information relating to normal system test items stored in a test item storage unit;

FIG. 7 is a view depicting an example of a table of information relating to abnormal system test items stored in a test item storage unit;

FIG. 8 is a view depicting normal system test numbers indicated in the table of FIG. 6 for the respective network apparatus included in the network system of FIG. 4;

FIG. 9 is a view depicting abnormal system test numbers indicated in the table of FIG. 7 for the respective network apparatus included in the network system of FIG. 4;

FIG. 10 is a view depicting an example of a table including information of prediction results in regard to normal system test items and stored in a prediction result storage unit;

FIG. 11 is a view depicting an example of a table including information of prediction results in regard to abnormal system test items and stored in a prediction result storage unit;

FIG. 12 is a view depicting an example of a table including information of test results in regard to normal system test items and stored in a test result storage unit;

FIG. 13 is a view depicting an example of a table including information of test results in regard to abnormal system test items and stored in a test result storage unit;

FIG. 14 is a view depicting an example of a table of results of comparison between prediction results stored in a prediction result storage unit and test results stored in a test result storage unit in regard to normal system test items;

FIG. 15 is a view depicting an example of a table of results of comparison between prediction results stored in a prediction result storage unit and test results stored in a test result storage unit in regard to abnormal system test items;

FIG. 16 is a view depicting an example of a table that indicates correspondence between analysis results depicted in FIGS. 14 and 15 and evaluation results regarding whether or not tuning may be required;

FIG. 17 is a view depicting a processing sequence between a network test apparatus and an information collection apparatus;

FIG. 18 is a view depicting a processing flow of a network test apparatus according to the present embodiment;

FIG. 19 is a view depicting a processing flow of an information collection apparatus according to the present embodiment; and

FIG. 20 is a view depicting an example of a configuration of hardware of a network test apparatus according to the present embodiment.

### DESCRIPTION OF EMBODIMENT

Recently, the configuration of a network is increasing in scale and complication. So it is becoming difficult for a manager to extract test items by manual operation and perform a network test.

Therefore, according to one aspect, the present technology provides a technique for performing a test of a network efficiently.

In the following, an embodiment of the present technology is described with reference to the drawings.

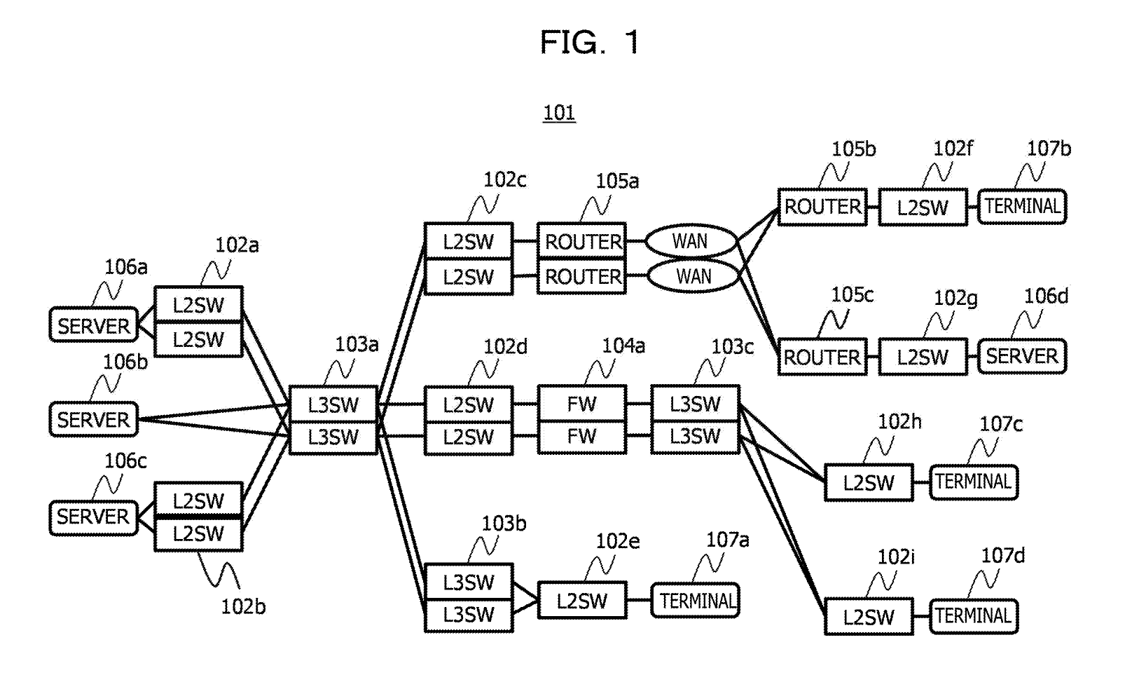

FIG. 1 is a view depicting an example of a configuration of a network system for which a test according to the present embodiment is performed. As depicted in FIG. 1, a network system 101 according to the present embodiment includes, for example, L2 switches (L2SW) 102a to 102i, L3 switches (L3SW) 103a to 103c, a firewall (FW) 104a, routers 105a to 105c, servers 106a to 106d, and terminals 107a to 107d. Further, part of the network system 101, the L2 switches 102a to 102d, the L3 switches 103a to 103c, the firewall 104a, and the router 105a have a redundant configuration.

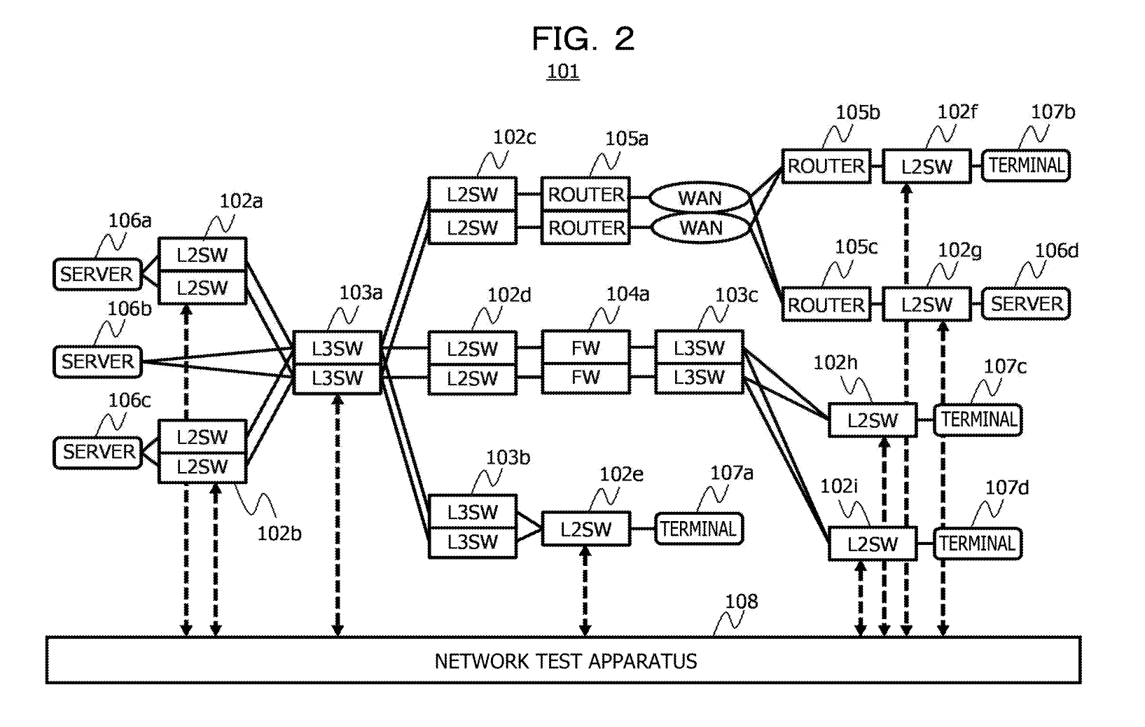

FIG. 2 is a view depicting an example in which a network test apparatus is installed in the network system 101 depicted in FIG. 1. In the example depicted in FIG. 2, each of the L2 switches (L2SW) 102a, 102b, and 102e to 102i and the L3 switch (L3SW) 103a included in the network system 101. The network system 101 and a network test apparatus 108 are coupled to each other by a network which can exchange information. In the following description, some network apparatus which are set in the network system 101 so as to be able to transmit and receive information to and from the network test apparatus 108 are referred to as information collection apparatus. In the example of FIG. 2, each of the L2 switches (L2SW) 102a, 102b, and 102e to 102i and the L3 switch (L3SW) 103a corresponds to an information collection apparatus.

The information collection apparatus performs transmission and reception of information relating to various tests to and from the network test apparatus 108. The information relating to a test is, for example, config information of the network apparatus included in the network system 101 or information of the response time period between different network apparatus, a communication path or a pop number when communication is performed between different information collection apparatus and so forth. In the example depicted in FIG. 2, a network apparatus positioned adjacent an end point or a server of the network system 101 is set as an information collection apparatus. However, the information collection apparatus may not necessarily be a network apparatus positioned adjacent an end point or a server of the network system 101. For example, an L2 switch (L2SW), an L3 switch (L3SW), a firewall (FW), a router or the like that is not positioned adjacent an end point or a server may be set as an information collection apparatus.

The network test apparatus 108 according to the present embodiment accepts an input of configuration information of the network system 101. The configuration information of the network system 101 is information of an identification number, an apparatus name, a device type, a host name, an internet protocol (IP) address, presence or absence of a redundant configuration and so forth of a network apparatus included in the network system 101. As a method for inputting information, for example, a user such as a manager may input configuration information of a network to the network test apparatus 108. Alternatively, a network manager may perform a process for causing design documents to be read in using an optical character reader (OCR) or the like, extracting configuration information of the network from the read in information and inputting the extracted configuration information to the network test apparatus 108.

The network test apparatus 108 creates test items and communication path information based on the configuration information. The communication path information is information of a coupling relationship to a plurality of information collection apparatus that are made a target of a test corresponding to a test item. The network test apparatus 108 instructs the information collection apparatus to collect config information of network apparatus existing on a communication path used when a test corresponding to a created test item is to be performed.

When each information collection apparatus accepts the instruction for collection of config information, it collects config information relating to the network apparatus of the test target and transmits the config information to the network test apparatus 108. The network test apparatus 108 receives the config information from the individual information collection apparatus and creates a prediction result for each test item based on the received config information.

The network test apparatus 108 instructs the information collection apparatus to carry out a communication test. When the information collection apparatus accepts the instruction to carry out a communication test from the network test apparatus 108, it transmits a result of the communication test (test result) to the network test apparatus 108. Then, the network test apparatus 108 compares the received test result and the prediction result with each other to perform evaluation whether or not the communication is normal.

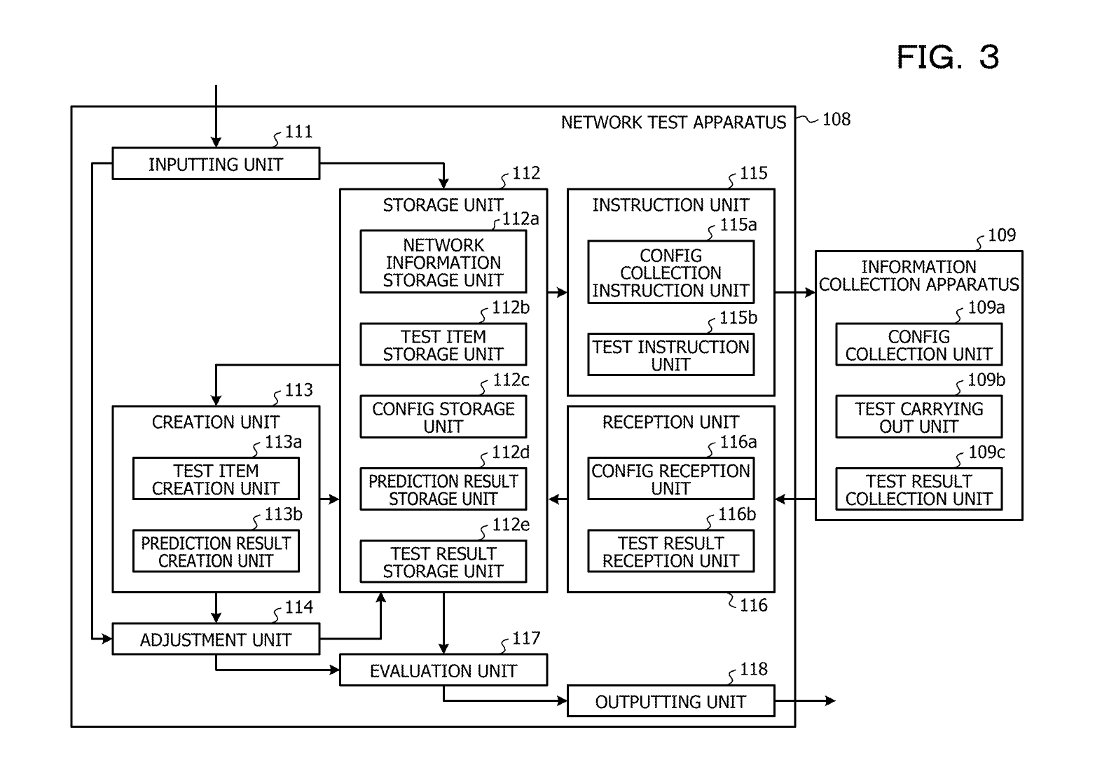

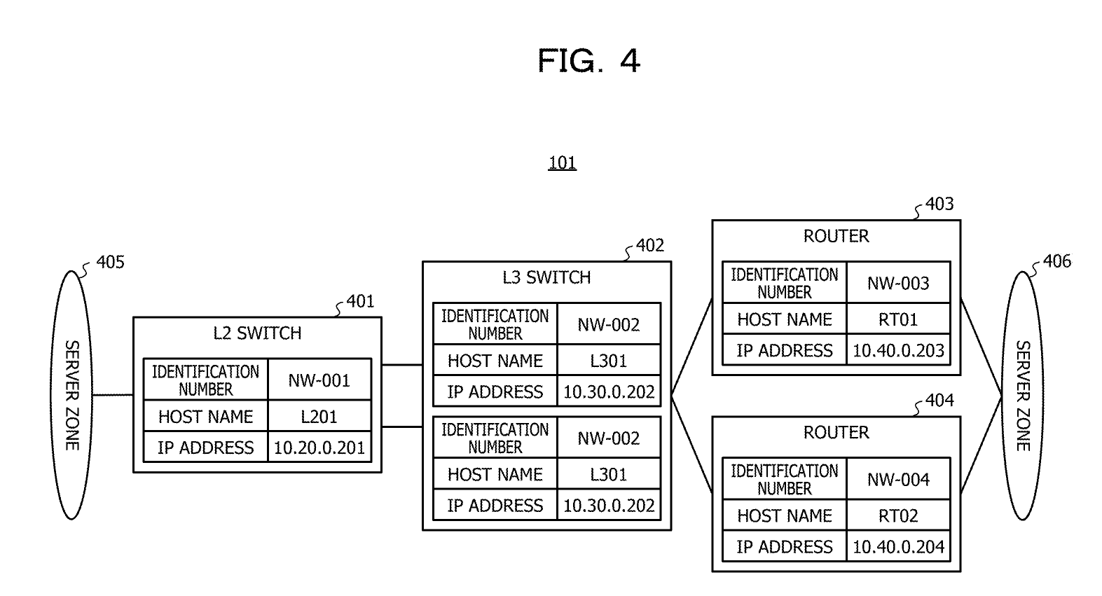

Now, a configuration of the network test apparatus 108 and the information collection apparatus 109 is described with reference to FIGS. 3 and 4.

FIG. 3 is a view depicting an example of a configuration of the network test apparatus 108 and the information collection apparatus 109 in the present embodiment. While a large number of apparatus is depicted in FIG. 2, in order to simplify description, the network system is configured such that, as depicted in FIG. 4. The network system depicted FIG. 4. is a small-scale network system 101 including server zones 405 and 406 each including one or a plurality of servers, an L2 switch 401, an L3 switch 402, and routers 403 and 404.

Referring to FIG. 3, the network test apparatus 108 includes an inputting unit 111, a storage unit 112, a creation unit 113, an adjustment unit 114, an instruction unit 115, a reception unit 116, an evaluation unit 117, and an outputting unit 118.

The inputting unit 111 accepts an input of configuration information of the network system 101 described, for example, in design documents or the like. The configuration information of the network system 101 is, for example, information of an identification number, an apparatus name, a device type (type such as an L2 switch, an L3 switch, a router or the like), a host name, an IP address, presence or absence of a redundant configuration, a coupling relationship of a network and so forth of a network apparatus included in the network system 101. The inputting unit 111 stores the accepted configuration information of the network system 101 into the storage unit 112. Further, the inputting unit 111 accepts an input of setting or change of information that is used as a reference when a test result of a network test of the network test apparatus 108 is evaluated. The information that is used as a reference when a test result is evaluated is information that is used as a reference in regard to what value is to be indicated by an actual test result with respect to a prediction result of a network test in order to make an evaluation that the network system 101 is in a normally operating state. If information as a reference is accepted from the inputting unit 111, the network test apparatus 108 transmits the information to the adjustment unit 114. Further, when the inputting unit 111 accepts an input for setting or change of a test item or a prediction result, it transmits the information to the adjustment unit 114.

The storage unit 112 includes a network information storage unit 112a, a test item storage unit 112b, a config storage unit 112c, a prediction result storage unit 112d, and a test result storage unit 112e.

Although, in the following, an example of information stored in the respective storage units is described, since this presupposes the network system 101 depicted in FIG. 4, the network system 101 is described briefly with reference to FIG. 4.

FIG. 4 is a view depicting a particular example of the network system according to the present embodiment. In the particular example depicted in FIG. 4, the server zone 405 and the server zone 406 are coupled to each other through the L2 switch 401, the L3 switch 402, and the routers 403 and 404. Here, it is assumed that the L2 switch 401 and the routers 403 and 404 coupled to the server zones 405 and 406 individually, are apparatus corresponding to the information collection apparatus 109. A cable between the L2 switch 401 and the L3 switch 402 has a redundant configuration. The L3 switch 402 is a virtual router redundancy protocol (VRRP) having a virtual IP address and has a redundant configuration. Alphanumeric characters described in each of frames of the L2 switch 401, the L3 switch 402, and the routers 403 and 404 depicted in FIG. 4 represent an identification number, a host name, and an IP address of each network apparatus from above. For example, to the L2 switch 401, an identification number NW-001, a host name L201, and an IP address 10.20.0.201 are allocated. To the L3 switch 402, an identification number NW-002, a host name L301, and an IP address 10.30.0.202 are allocated. To the router 403, an identification number NW-003, a host name RT01, and an IP address 10.40.0.203 are allocated. To the router 404, an identification number NW-004, a host name RT02, and an IP address 10.40.0.204 are allocated.

When the network described hereinabove with reference to FIG. 4 is to be utilized, the network information storage unit 112a stores configuration information of the network system 101 received from the inputting unit 111. For example, the network information storage unit 112a stores the configuration information in the form of a table.

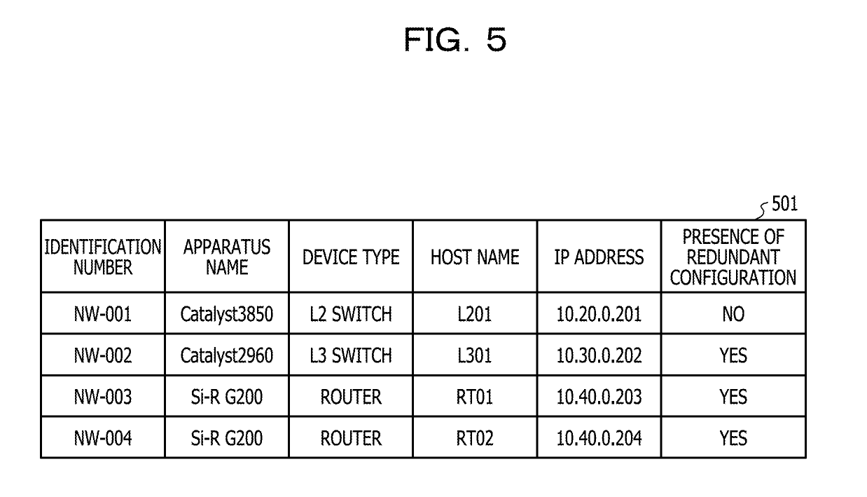

FIG. 5 is a view depicting an example of a table of configuration information of the network system 101 stored in the network information storage unit 112a. As indicated in a table 501 of FIG. 5, the network information storage unit 112a stores, for example, an identification number, an apparatus name, a device type (L2 switch, L3 switch, or router), a host name, an IP address, presence or absence of a redundant configuration and so forth of each of the network apparatus included in the network system 101.

The test item storage unit 112b stores test items created by a test item creation unit 113a hereinafter described. For example, the test item storage unit 112b stores the test items in the form of a table.

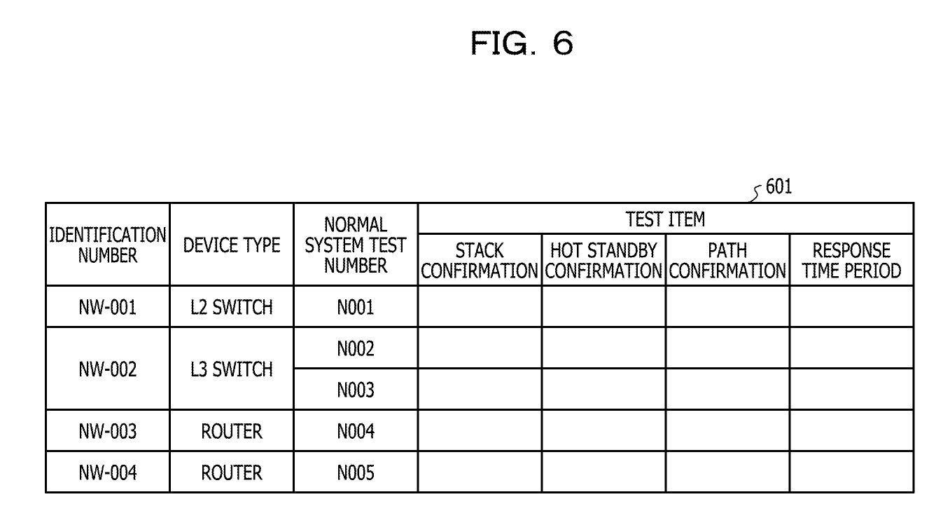

FIG. 6 is a view depicting an example of a table of information relating to normal system test items stored in the test item storage unit 112b. The normal system test items depicted in a table 601 of FIG. 6 are items for testing whether communication is normal when communication between the network apparatus included in the network system 101 is possible. The items for testing whether communication is normal are items, for example, for stack confirmation (confirmation of a redundant configuration for a switch), hot standby confirmation (confirmation of a redundant configuration for a router and a FW), path confirmation when communication is performed, communication confirmation between the information collection apparatus 109 and so forth. The item for communication confirmation is an item of a target for deciding whether communication is normal based on a response time period of a packet between the information collection apparatus 109.

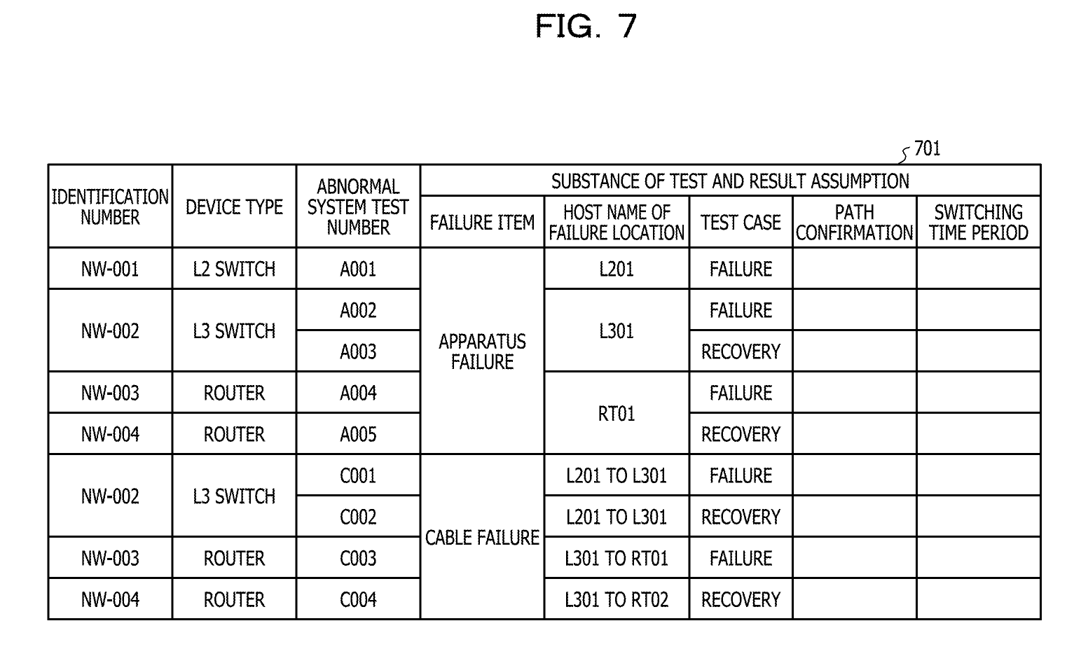

FIG. 7 is a view depicting an example of a table of information relating to abnormal system test items stored in the test item storage unit 112b. The abnormal system test items depicted in a table 701 of FIG. 7 are items for testing whether a location having a redundant configuration operates normally, when a failure of a network apparatus between the information collection apparatus 109 between which communication is to be performed occurs or when a failure occurs with a cable that couples the information collection apparatus 109 between which communication is to be performed. The abnormal system test items are items, for example, for path confirmation in a network, confirmation of a switching time period of a network apparatus or a cable having a redundant configuration and so forth. The abnormal system test items are set for two cases including, as a test case for each switch, a router, and a cable between network apparatus having a redundant configuration, a case in which a failure occurs and another case in which recovery is performed.

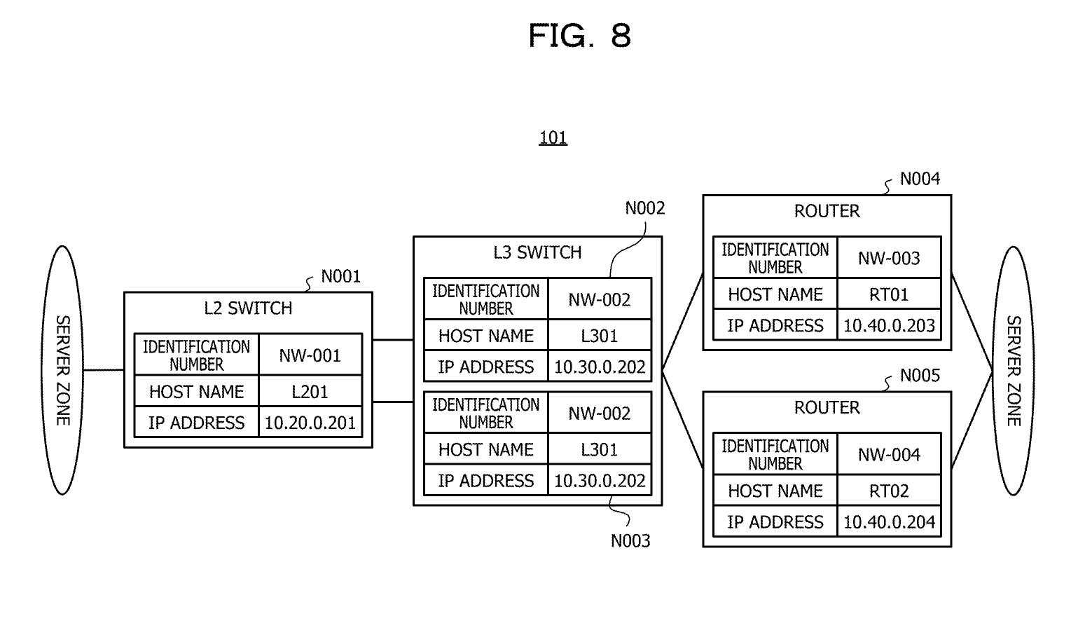

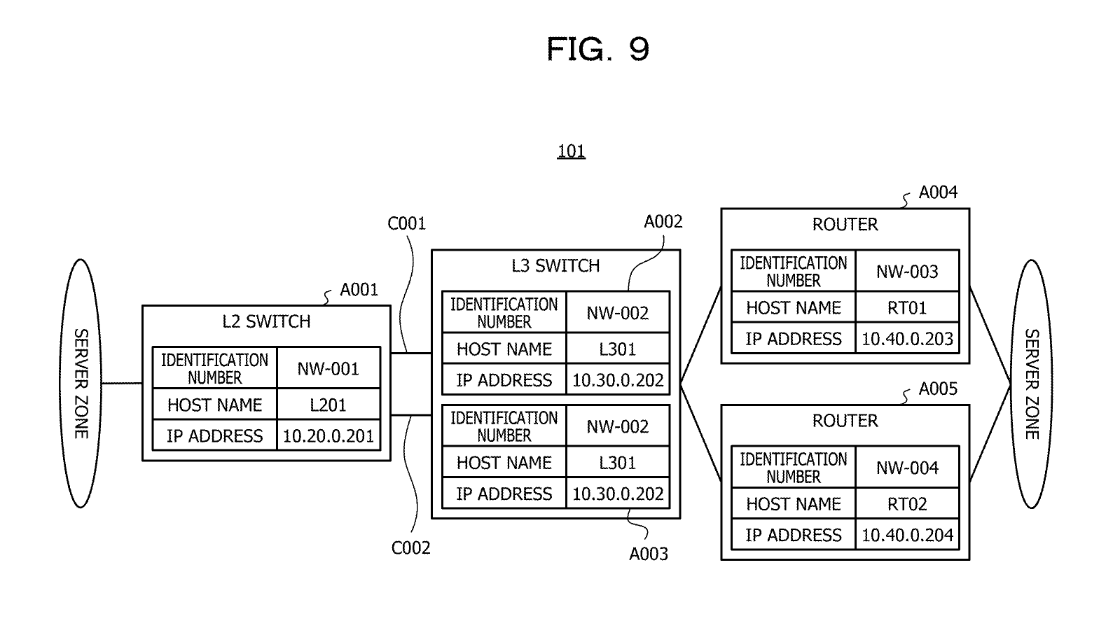

FIG. 8 is a view depicting normal system test numbers indicated in the table 601 of FIG. 6 for the respective network apparatus included in the network system 101 of FIG. 4. FIG. 9 is a view depicting abnormal system test numbers indicated in the table 701 of FIG. 7 for the respective network apparatus included in the network system 101 of FIG. 4. When a test is to be performed, the network test apparatus 108 performs confirmation of the normal system test items and the abnormal system test items for each of terminals to which a normal system test number and an abnormal system test number are applied.

The config storage unit 112c stores information included in the config received from the information collection apparatus 109. The information included in the config is, for example, information relating to a redundant configuration (information of stack and hot standby), and is information regarding whether each of terminals in a redundant configuration is Active (Master) or Standby (Backup), information of a switching time period when a network apparatus having a redundant configuration fails or the like. The config storage unit 112c stores information also of a communication path between terminals that receive information from the information collection apparatus 109 and a pop number between the terminals. The information relating to a communication path or a pop number between terminals is collected by the information collection apparatus 109, for example, by executing a trace route command.

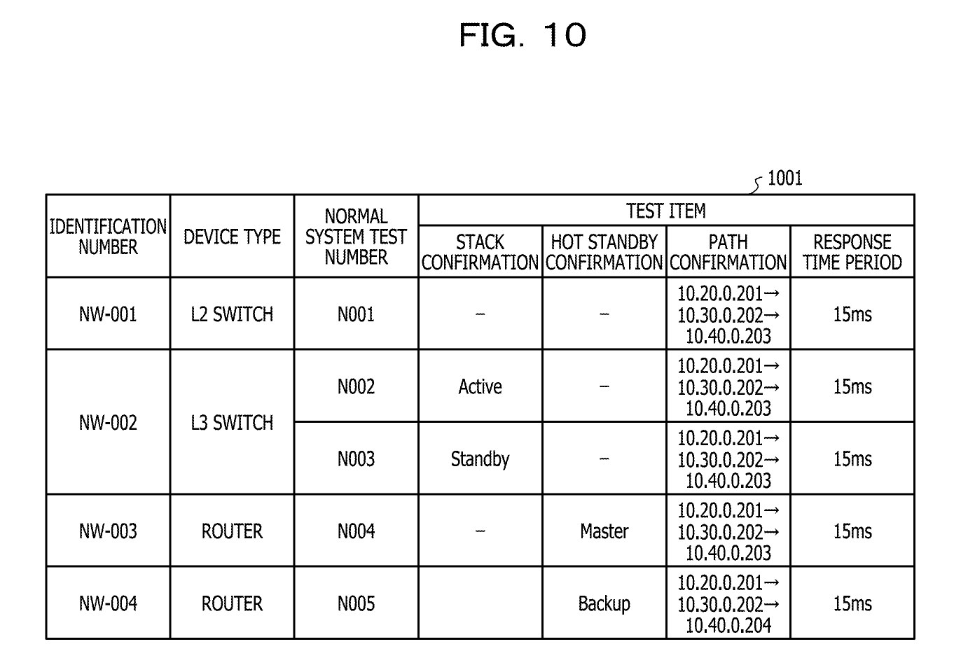

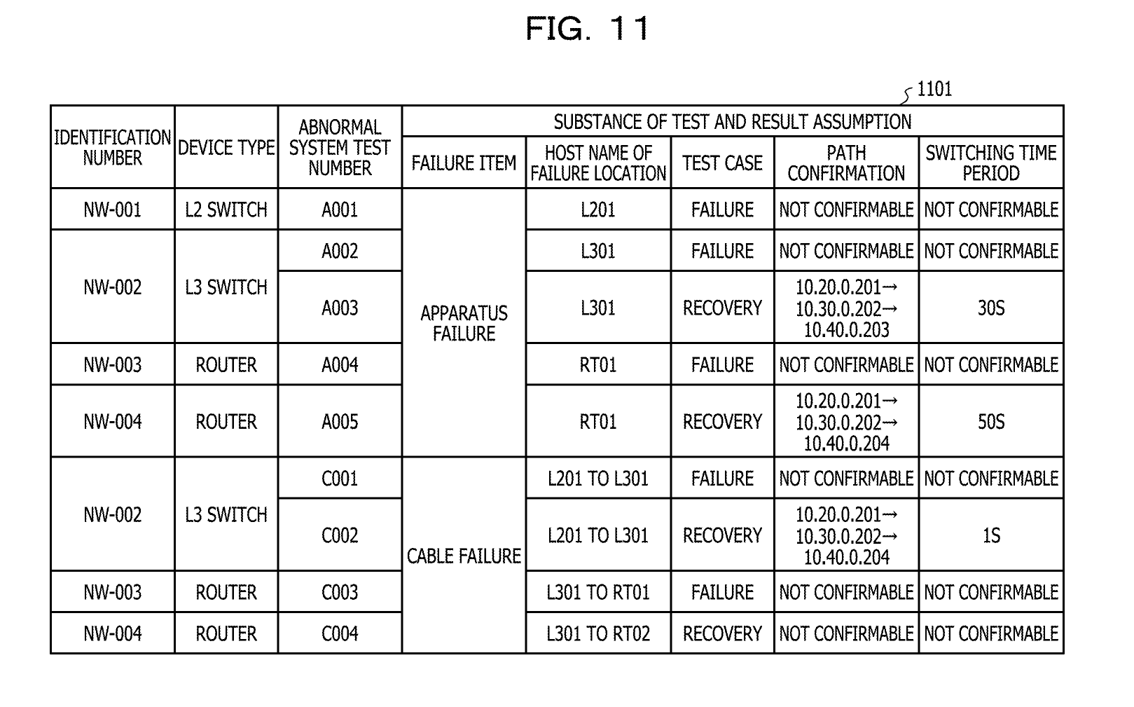

The prediction result storage unit 112d stores a prediction result for each test item created by a prediction result creation unit 113b of the creation unit 113 hereinafter described based on the information included in the config stored in the config storage unit 112c. For example, the prediction result storage unit 112d stores such prediction results in the form of a table. FIG. 10 is a view depicting an example of a table including information of prediction results for normal system test items stored in the prediction result storage unit 112d. FIG. 11 is a view depicting an example of a table including information of prediction results for abnormal system test items stored in the prediction result storage unit 112d.

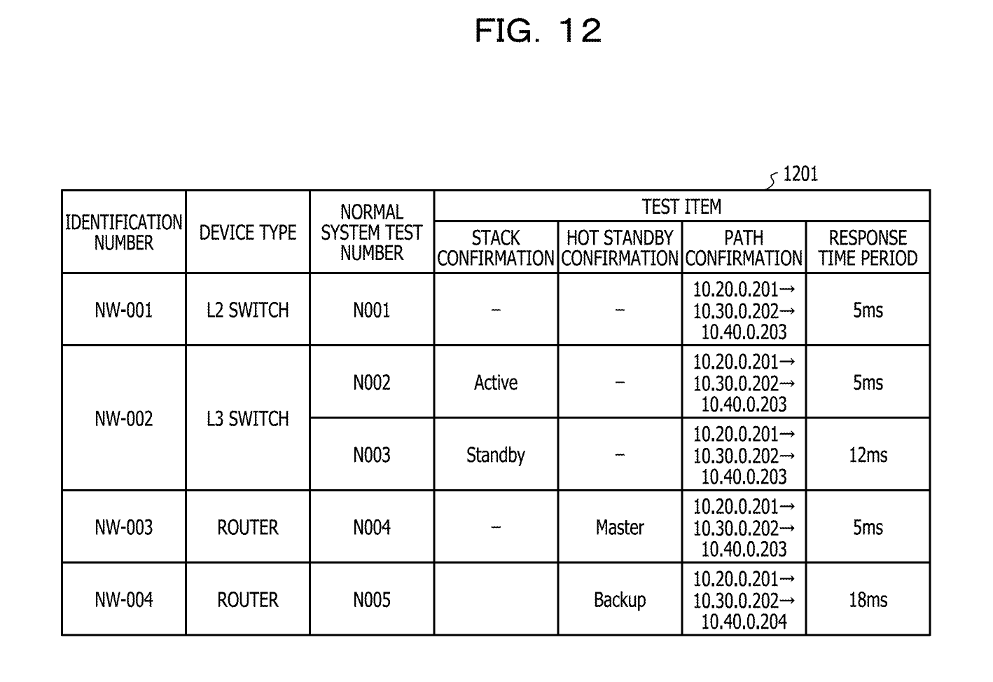

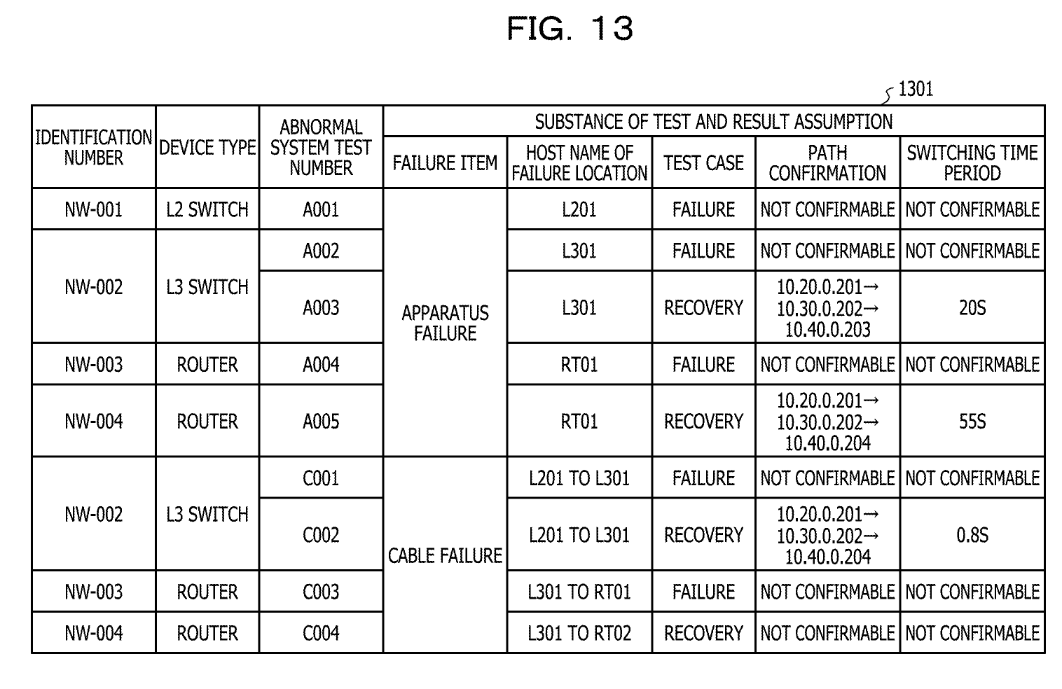

The test result storage unit 112e stores test results of communication between the information collection apparatus 109 in the form of a table. For example, the test result storage unit 112e receives test results (stack confirmation, hot standby confirmation, path confirmation, response time period, and switching time period) corresponding to the respective test items stored in the test item storage unit 112b from each information collection apparatus 109 and stores the test results as depicted in FIGS. 12 and 13. FIG. 12 is a view depicting an example of a table including information of test results for the normal system test items stored in the test result storage unit 112e. FIG. 13 is a view depicting an example of a table including test results for the abnormal system test items stored in the test result storage unit 112e.

The creation unit 113 includes a test item creation unit 113a and a prediction result creation unit 113b.

The test item creation unit 113a creates test items based on the configuration information of the network system 101 stored in the network information storage unit 112a of the storage unit 112. The test items created by the test item creation unit 113a are, for example, items for stack confirmation, hot standby conformation, path confirmation, a response time period, a switching time period and so forth. The test item creation unit 113a confirms whether the network apparatus stored in the network information storage unit 112a include a network apparatus that has a redundant configuration. If a network apparatus having a redundant configuration exists, and the apparatus is a switch, an item for stack confirmation is created, but if the apparatus is a router, an item for hot standby confirmation is creased. Further, the test item creation unit 113a creates, irrespective of the type of the apparatus, an item for path confirmation and an item for a response time period along the communication path when communication with a different information collection apparatus 109 included in the network system 101. The test item creation unit 113a outputs the created test items to the test item storage unit 112b.

The prediction result creation unit 113b creates prediction results for the test items stored in the test item storage unit 112b based on the information included in the config stored in the config storage unit 112c. The prediction results include those for the normal system test items and those for the abnormal system test items. They are described in order below.

First, creation of prediction results for the normal system test items is described. The prediction result creation unit 113b creates prediction results relating to a redundant configuration based on the stack information and hot standby information of the respective terminals in the network stored in the network information storage unit 112a. The prediction results relating to a redundant configuration reflect information of whether each of the terminals having a redundant configuration is Active (Master) or Standby (Backup). Further, the prediction result creation unit 113b creates a prediction result corresponding to such path confirmation as depicted, for example, in a table 1001 of FIG. 10 based on the information of communication path between the information collection apparatus 109 and the different information collection apparatus 109 acquired by causing the information collection apparatus 109 to execute the trace route command. Further, the prediction result creation unit 113b creates a prediction result corresponding to the item for a response time period in response to the pop number on the path between the information collection apparatus 109.

In the network system 101 of FIG. 4, the pop number between the server zone 405 and the other server zone 406 is 3. For example, if a setting of 5 ms per one hop is accepted in advance, the prediction result of the response time period between the server zone 405 and the server zone 406 is 15 ms. However, the prediction result of the response time period may be determined by the method described above, besides, for example, a setting of a given period of time may be accepted in advance to set the period of time as a prediction result of the response time period.

Now, creation of prediction results for the abnormal system test items is described. The prediction result creation unit 113b creates a prediction result for a communication path for the item for path confirmation of an abnormal system test item similarly as upon creation of a prediction result of path confirmation for a normal system test item. Further, if a failure occurs with the Active (Master) side of a network apparatus that has a redundant configuration stored in the config storage unit 112c, the prediction result creation unit 113b creates a prediction result for the item of a switching time period based on the switching time period until switching to the Standby (Backup) side is performed. However, the method for creating a prediction result for the item of a switching time period is not limited to that described above. For example, the sum total of the switching time periods of the respective network apparatus between the information collection apparatus 109 between which a test for communication is to be performed may be determined as a prediction result for the item of a switching time period. Alternatively, the switching time period of a network apparatus that indicates the greatest switching time period among the respective network apparatus between the information collection apparatus 109 may be determined as a prediction result for the item of a switching time period. By performing such a process as described above, prediction results individually corresponding to the network systems 101 may be created. The prediction result creation unit 113b outputs the created prediction results to the prediction result storage unit 112d and the adjustment unit 114.

The adjustment unit 114 outputs threshold values to be adjusted when prediction results and test results are to be evaluated to the evaluation unit 117.

Referring to FIG. 3, the instruction unit 115 includes a config collection instruction unit 115a and a test instruction unit 115b. The config collection instruction unit 115a transmits an instruction for collection of config to the information collection apparatus 109 based on the network information stored in the network information storage unit 112a. The test instruction unit 115b transmits an instruction to carry out a communication test between the information collection apparatus 109 in the network to the information collection apparatus 109.

The reception unit 116 includes a config reception unit 116a and a test result reception unit 116b. The config reception unit 116a receives the config collected in accordance with an instruction from the config collection instruction unit 115a from the information collection apparatus 109 and transmits the collected config to the config storage unit 112c. The test result reception unit 116b receives a result of a text carried out in accordance with an instruction from the test instruction unit 115b from the information collection apparatus 109 and transmits the result to the test result storage unit 112e.

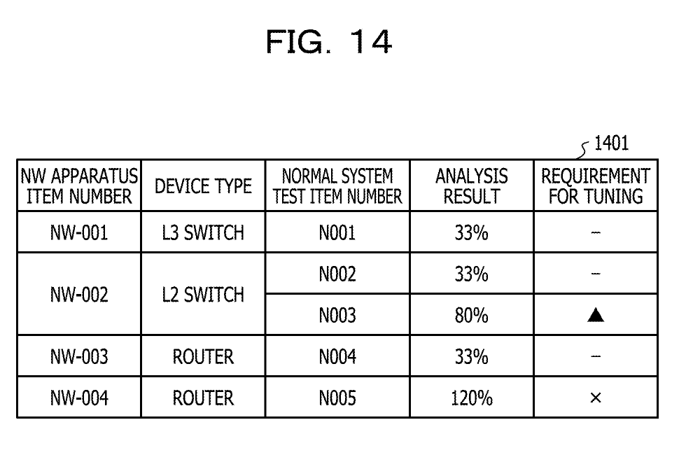

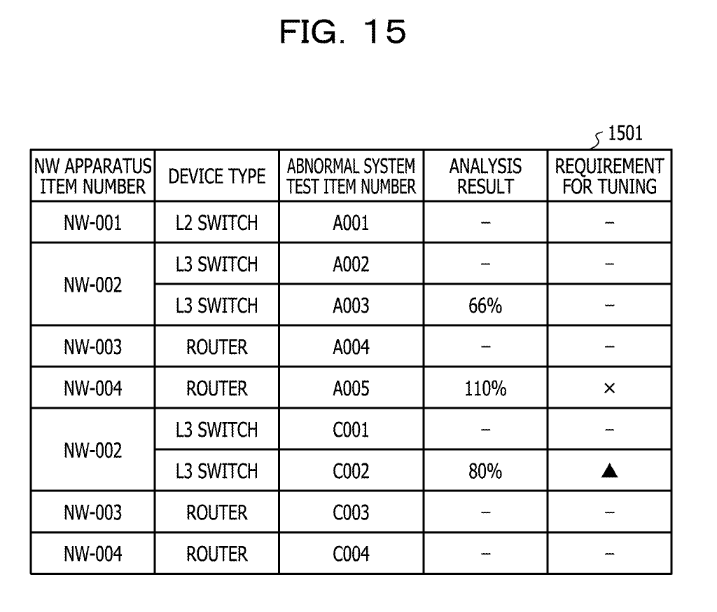

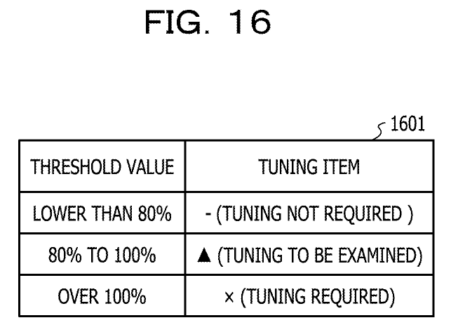

The evaluation unit 117 compares the prediction results stored in the prediction result storage unit 112d and the test results stored in the test result storage unit 112e with each other to perform evaluation regarding whether communication between the information collection apparatus 109 is normal. FIG. 14 is a view depicting results of comparison between prediction results stored in the prediction result storage unit 112d and test results stored in the test result storage unit 112e in regard to the normal system test items. FIG. 15 is a view depicting an example of a table of result of comparison between prediction results stored in the prediction result storage unit 112d and test results stored in the test result storage unit 112e in regard to the abnormal system test items. FIG. 16 is a view depicting an example of a table indicating correspondence between the analysis results depicted in FIGS. 14 and 15 and evaluation results regarding whether tuning may be required. The evaluation unit 117 calculates ratios of the response time periods and the switching time periods stored in the test result storage unit 112e to the prediction results of the response time period and the switching time period stored in the prediction result storage unit 112d as analysis results. Then, the evaluation unit 117 performs evaluation of the analysis results based on the table depicted in FIG. 16. If the ratio (analysis result) of the respective test results of the response time period and the switching time period to the respective prediction results of the response time period and the switching time period in the prediction results are lower than 80% as depicted in FIG. 13, the evaluation unit 117 evaluates that tuning may not be required, but if the ratio ranges of 80% to 100%, the evaluation unit 117 evaluates that examination of tuning may be required. However, if the ratio exceeds 100%, the evaluation unit 117 evaluates that tuning may be required. Then, the evaluation unit 117 outputs the evaluation result to the outputting unit 118. As regards the ratio of the threshold value for an analysis result, for example, the threshold value may be set such that the evaluation varies in response to an evaluation result in the past, or may be set in advance by the user utilizing the inputting unit 111 and the adjustment unit 114. As a particular example when a threshold value is set, for example, where it is utilized by such a system that it is demanded to satisfy a severe condition for a communication environment as in the case of a bank, the threshold value for a region in which tuning may not be required may be set to less than 30%; the threshold value for a region for which examination of tuning may be required may be set to 30% to 50%; and the threshold value for a region in which tuning may be required may be set so as to be higher than 50%.

Alternatively, in such a case that the consistency of information may not be assured or in such a case that an error that makes it difficult to acquire information occurs in any item other than the item for the switching time period between a prediction result and a test result for each test item number, such setting that tuning may be required may be used.

Here, a particular example of evaluation where a table of evaluation results for the normal system test items depicted in FIG. 14 is described. Since, as depicted in FIG. 14, analysis results for the normal system test item numbers of N001, N002, and N004 indicate that the ratio of the test result to the prediction result is 33% (prediction result=15 ms and test result=5 ms), it is evaluated that tuning may not be required in accordance with the table of FIG. 16. Meanwhile, since the L2 switch of NW-002 corresponding to the normal system test item number of N003 indicates that the ratio of the test result to the prediction result is 80% (prediction result=15 ms and test result=12 ms), it is evaluated that examination of tuning may be required in accordance with the table of FIG. 16. Since the router of NW-004 corresponding to the test item number of N005 indicates that the ratio of the test result to the prediction result is 120%, it is evaluated that tuning may be required in accordance with the table of FIG. 16.

Further, a particular example of evaluation where a table of evaluation results for the abnormal system test items depicted in FIG. 15 is described. Since, as depicted in FIG. 15, the L3 switch of NW-002 corresponding to the abnormal system test item number A003 indicates that the ratio of the test result to the prediction result is 66% (prediction result=30 seconds and test result=20 seconds), it is evaluated that tuning may not be required in accordance with the table of FIG. 16. Meanwhile, since the router of NW-004 corresponding to the abnormal system test item number of A005 indicates that the ratio of the test result to the prediction result is 110% (prediction result=50 seconds and test result=55 seconds), it is evaluated that tuning may be required in accordance with the table of FIG. 16. Further, since the cable between L201 to L301 corresponding to the abnormal system test item number of C002 indicates that the ratio of the test result to the prediction result is 80% (prediction result=one second and test result=0.8 seconds), it is evaluated that examination of tuning may be required in accordance with the table of FIG. 16.

The outputting unit 118 outputs the evaluation results of the evaluation unit 117.

Now, a configuration of the information collection apparatus 109 is described. Referring to FIG. 3, the information collection apparatus 109 includes a config collection unit 109a, a test carrying out unit 109b, and a test result collection unit 109c. The config collection unit 109a performs collection of the config based on an instruction to collect the config of network terminals received from the config collection instruction unit 115a of the network test apparatus 108. The config collection unit 109a transmits the collected config to the network test apparatus 108. As a method by which the config collection unit 109a collects the config, there is a method by which a command such as “Show running-config all” or “tracert” is sent to a terminal which receives an instruction for collection. However, the method for collecting the config is not limited to that described above. The test carrying out unit 109b performs a communication test between the information collection apparatus 109 based on an instruction for carrying out a test received from the test instruction unit 115b of the information collection apparatus 109. The test result collection unit 109c collects results of tests carried out by the test carrying out unit 109b and transmits the collected test results to the network test apparatus 108. Further, when results of tests relating to a redundant configuration are to be collected, for example, the user may stop the function at the Active (Master) side to acquire test results at Standby (Backup).

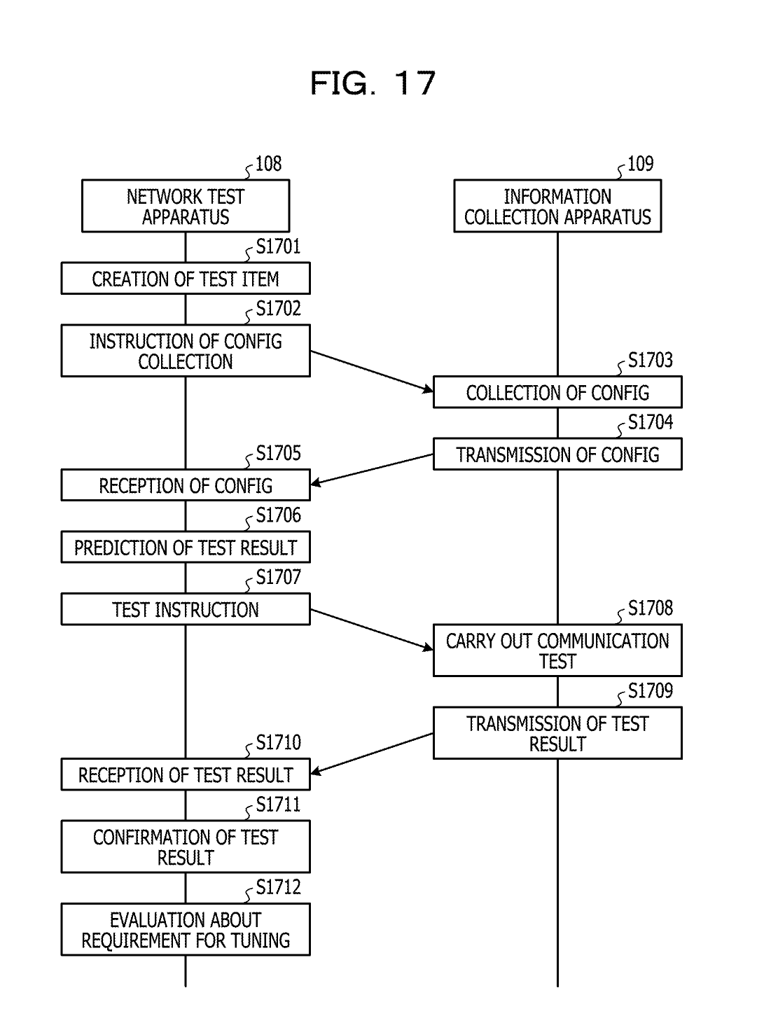

A processing sequence between the network test apparatus 108 and the information collection apparatus 109 in which the configuration described above is used is described below. FIG. 17 is a view depicting a processing sequence between the network test apparatus 108 and the information collection apparatus 109.

The network test apparatus 108 accepts an input of configuration information of the network (adjacent information of terminals, information of terminals included in the network and so forth) and performs creation of test items based on the information by the test item creation unit 113a (step S1701). Then, the config collection instruction unit 115a of the network test apparatus 108 instructs the information collection apparatus 109 to collect the config in order to create prediction results for the test items (step S1702).

The information collection apparatus 109 performs, based on the instruction for collection of the config from the config collection instruction unit 115a of the network test apparatus 108 (step S1702), collection of the config by the config collection unit 109a (step S1703) and transmits the collected config to the network test apparatus 108 (step S1704). The network test apparatus 108 receives the collected config from the information collection apparatus 109 by the config reception unit 116a (step S1705) and stores the received config into the config storage unit 112c. The network test apparatus 108 performs creation of prediction results by the prediction result creation unit 113b based on the information stored in the test item storage unit 112b and the config storage unit 112c (step S1706). Then, in order to perform confirmation of whether tuning of the network system may be required, the network test apparatus 108 instructs the information collection apparatus 109 to carry out a test and collect results of the test by the test instruction unit 115b (step S1707).

After the information collection apparatus 109 receives the instruction relating to the test from the network test apparatus 108, it carries out a test by the test carrying out unit 109b in accordance with the substance of the received instruction for a test (step S1708). Then, the information collection apparatus 109 collects results of the carried out test by the test result collection unit 109c and transmits the collected information to the network test apparatus 108 (step S1709).

The test result reception unit 116b of the network test apparatus 108 receives the test results from the information collection apparatus 109 (step S1710), and then compares the information of the prediction results stored in the prediction result storage unit 112d and the information stored in the test result storage unit 112e with each other (step S1711) and performs evaluation regarding whether tuning may be required by the evaluation unit 117 (step S1712).

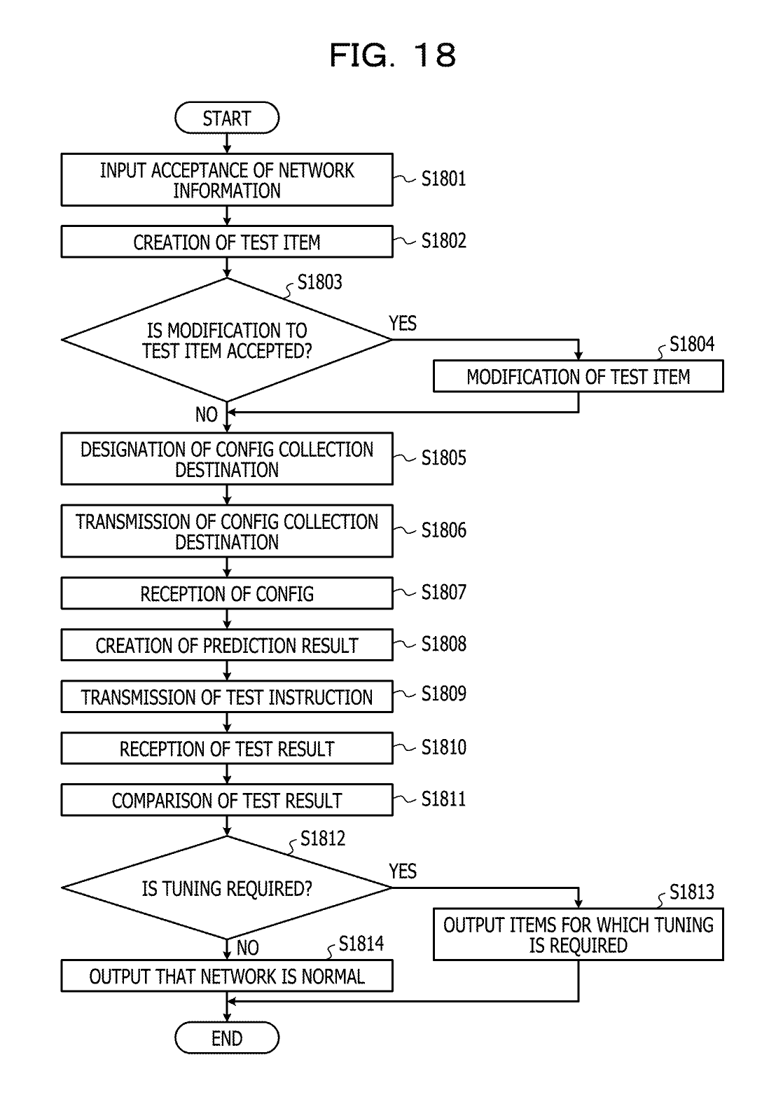

FIG. 18 is a view depicting a processing flow of the network test apparatus 108 according to the present embodiment.

The network test apparatus 108 according to the present embodiment accepts an input of configuration information of a network (step S1801) and stores the information whose input is accepted into the network information storage unit 112a of the storage unit 112. Then, the network test apparatus 108 performs creation of test items by the test item creation unit 113a of the creation unit 113 based on the information stored in the network information storage unit 112a (step S1802). After the creation of test items, the network test apparatus 108 outputs the created test items to the outputting unit 118 to perform confirmation regarding whether modification to a test item is accepted for the outputted information (step S1803). If modification to a test item is accepted (step S1803: Yes), the adjustment unit 114 performs modification to the test item (step S1804). However, if modification to a test item is not accepted (step S1803: No) or if modification to a test item is accepted and then modification by the adjustment unit 114 is completed (step S1804), the network test apparatus 108 designates terminals in the network to be used for a communication test corresponding to the test items as a collection destination of the config (step S1805). The network test apparatus 108 transmits information of the collection destination of the config to the terminals in the network designated as the collection destination (step S1806). The network test apparatus 108 receives, from the information collection apparatus 109, the config collected from the terminals in the network designated as the collection destination of config by the terminals in the network to which the instruction for config collection has been transmitted (step S1807). The prediction result creation unit 113b of the network test apparatus 108 creates a prediction result for each test item created by the test item creation unit 113a based on the config received from the terminals in the network (step S1808).

After the prediction results are created by the prediction result creation unit 113b (step S1808), the network test apparatus 108 transmits, in order to perform comparison between test results and the prediction results of the network, an instruction for the test from the test instruction unit 115b to the information collection apparatus 109 (step S1809).

The network test apparatus 108 receives the test results from the information collection apparatus 109 by the test result reception unit 116b (step S1810) and performs comparison of the test results with the prediction results stored in the test result storage unit 112e (step S1811). The evaluation unit 117 of the network test apparatus 108 performs, based on a result of the comparison, an evaluation regarding whether tuning may be required (step S1812). If tuning may be required based on a result of the evaluation by the evaluation unit 117 of the network test apparatus 108 (step S1812: Yes), the network test apparatus 108 transmits the items for which tuning may be required to the outputting apparatus (step S1813). However, if tuning may not be required (step S1812: No), the network test apparatus 108 transmits information that the network is normal to the outputting apparatus (step S1814).

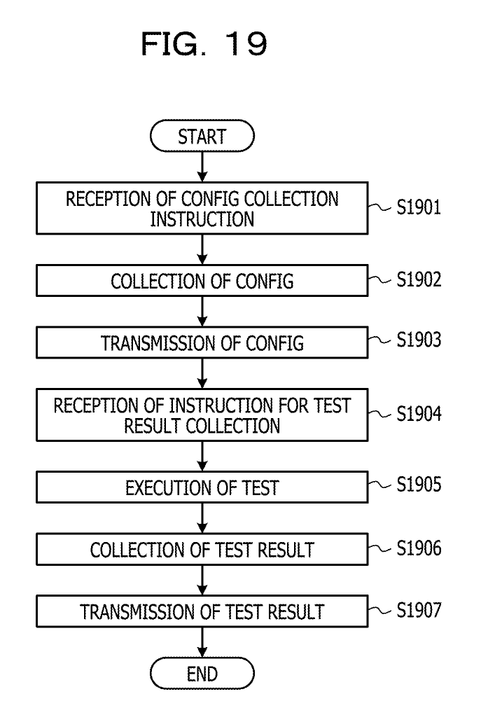

FIG. 19 is a view depicting a processing flow of the information collection apparatus 109 according to the present embodiment.

After the information collection apparatus 109 receives an instruction for config collection from the config collection instruction unit 115a of the network test apparatus 108 (step S1901), the config collection unit 109a thereof performs collection of the config of the terminals in the network by which the instruction for config collection is received (step S1902). After the collection of the config (step S1902) is completed, the config collection unit 109a transmits the collected config to the network test apparatus 108 (step S1903).

After the information collection apparatus 109 transmits the config and receives an instruction for test result collection from the test instruction unit 115b (step S1904), the test carrying out unit 109b thereof executes a test in accordance with the instruction for test result collection (step S1905). The test result collection unit 109c collects results of the test (step S1906) and transmits the collected test results to the network test apparatus 108 (step S1907).

The processes according to the present embodiment are not limited to those described above.

For example, communication between all information collection apparatus may be evaluated, besides, communication only between information collection apparatus upon which a load is applied especially may be performed. By setting in advance such that, for locations for which evaluation of communication may not be performed, recovery is not performed, processes may be decreased.

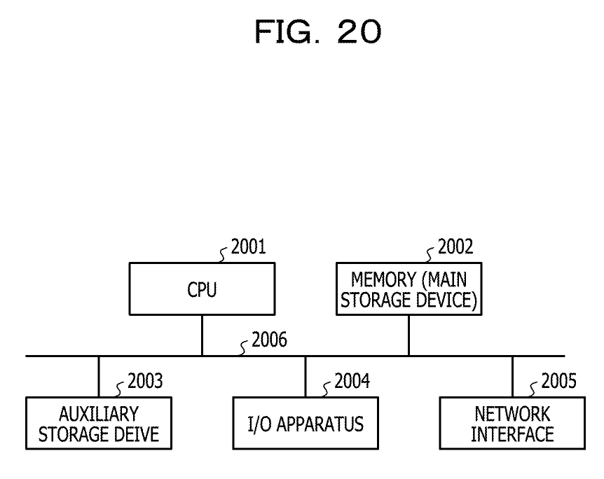

FIG. 20 is a view depicting an example of a configuration of hardware of the network test apparatus 108 according to the present embodiment. The network test apparatus 108 according to the present embodiment includes a central processing unit (CPU) 2001, a memory (main memory device) 2002, an auxiliary storage device 2003, an input/output (I/O) apparatus 2004, a network interface 2005, and a bus 2006. The components mentioned are coupled to each other by a bus.

The CPU 2001 controls the entire network test apparatus 108. The memory 2002 has stored therein a program for performing processing according to the present embodiment.

The CPU 2001 reads out information relating to a network from the auxiliary storage device 2003 and stores the information into the memory 2002. Further, the CPU 2001 executes management of a server and a test based on the information stored in the memory 2002. Information relating to all tests may not be stored in the memory 2002, but only data to be used in processing may be stored in the memory 2002. Further, the program relating to the tests described above may be stored in the auxiliary storage device 2003, besides, may be stored, for example, in a portable medium that is inserted into the computer such as a disk.

The I/O apparatus 2004 accepts an input of a value, for example, when modification to test items, modification to prediction results and so forth from an inputting apparatus are to be performed. Further, a prediction result created by the creation unit 113 or a result of evaluation by the evaluation unit 117 is displayed on a display unit or the like.

The network interface 2005 is an interface apparatus that performs management of exchange of information with the network test apparatus 108 in the network.

The bus 2006 is a communication path that couples the component apparatus described above to each other to perform exchange of data.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A network test method comprising:
acquiring information of a type of each of a plurality of terminals included in a network and a coupling relationship of the plurality of terminals;
creating, based on the acquired information of the types of the plurality of terminals and the coupling relationship of the plurality of terminals, a test item of a communication test to be executed in the network and a path of the network when a test corresponding to the test item is to be performed;
acquiring setting information including a switching time period of a terminal or terminals having a redundant configuration from among the plurality of terminals included in the created path of the network from information processing terminals included in the network;
predicting, based on the switching time period acquired from the information processing terminals, a result of the communication test according to the switching time period in the path of the network through the terminal or terminals having the redundant configuration;
requesting the information processing terminals included in the network to carry out the communication test; and
evaluating communication in the network by performing comparison between a result of the prediction and the result of the communication test acquired from the information processing terminals included in the network for which the communication test is executed in response to the request.

2. The network test method according to claim 1, wherein the evaluation includes outputting an evaluation result according to a displacement amount obtained by the comparison.

3. The network test method according to claim 1, wherein the evaluation includes evaluating whether or not tuning relating to the network is to be performed in response to a displacement amount obtained by the comparison.

4. The network test method according to claim 1, wherein the result of the prediction corresponds to a total value of switching time periods of the terminal or terminals having the redundant configuration from among the plurality of terminals included in the path of the network.

5. The network test method according to claim 1, wherein the result of the prediction corresponds to a period of time that indicates a maximum value from among the switching time periods of the terminal or terminals having the redundant configuration from among the plurality of terminals included in the path of the network.

6. A network test apparatus comprising:
a memory; and
a processor coupled to the memory and the processor configured to:
acquire information of a type of each of a plurality of terminals included in a network and a coupling relationship of the plurality of terminals;
create, based on the acquired information of the types of the plurality of terminals and the coupling relationship of the plurality of terminals, a test item of a communication test to be executed in the network and a path of the network when a test corresponding to the test item is to be performed;
acquire setting information including a switching time period of a terminal or terminals having a redundant configuration from among the plurality of terminals included in the created path of the network from information processing terminals included in the network;
predict, based on the switching time period acquired from the information processing terminals, a result of the communication test according to the switching time period in the path of the network through the terminal or terminals having the redundant configuration;
request the information processing terminals included in the network to carry out the communication test; and
evaluate communication in the network by performing comparison between a result of the prediction and the result of the communication test acquired from the information processing terminals included in the network for which the communication test is executed in response to the request.

7. A non-transitory computer-readable storage medium storing a network test program that causes a computer to execute a process, the process comprising:
acquiring information of a type of each of a plurality of terminals included in a network and a coupling relationship of the plurality of terminals;
creating, based on the acquired information of the types of the plurality of terminals and the coupling relationship of the plurality of terminals, a test item of a communication test to be executed in the network and a path of the network when a test corresponding to the test item is to be performed;
acquiring setting information including a switching time period of a terminal or terminals having a redundant configuration from among the plurality of terminals included in the created path of the network from information processing terminals included in the network;
predicting, based on the switching time period acquired from the information processing terminals, a result of the communication test according to the switching time period in the path of the network through the terminal or terminals having the redundant configuration;
requesting the information processing terminals included in the network to carry out the communication test; and
evaluating communication in the network by performing comparison between a result of the prediction and the result of the communication test acquired from the information processing terminals included in the network for which the communication test is executed in response to the request.
